(19) United States
(12) Patent Application Publication
(10) Pub. No.: US 2005/0284889 A1
(43) Pub. Date: Dec. 29, 2005

(54) Hand wash system

(76) Inventor: Mark DuBois, Boynton Beach, FL (US)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 10/876,506

(22) Filed: Jun. 25, 2004

(51) Int. Cl. B67D 1/07

(52) U.S. Cl. 222/192; 222/185.1

(57) ABSTRACT

A hand wash system, comprising a fluid reservoir including an upper face, a lower face and a side face, with the lower face having a surface area that is greater than a surface area of the upper face, and an opening in the side face for discharging fluid from the reservoir. Embodiments of the present invention further include an integrated soap holder, a towel protrusion, as well as a handle.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a hand wash system having a gravity-fed water reservoir.

### BACKGROUND OF THE INVENTION

There are often situations when someone would like to wash their hands. Outdoorsmen may find themselves in remote locations and would like to wash-up after a day of activities. Agricultural workers may want to wash-up after a day's work. At sporting events, athletes may want to wash-up after a competition. While there are water-less hand sanitizers and such available, there's really no substitute for having an available water supply for washing purposes.

Additionally, in certain circumstances, there is no substitute for water. For example, persons working with dangerous or irritating chemicals are often advised or required to flush the skin or eyes with a considerable amount of water as an initial course of treatment. However, remote field workers often don't have access to water flowing from pipes.

Individuals in such situations may use drinking water from a cooler or other container to rinse, wash, or flush. Such containers are difficult to manage when attempting to pour water onto the hands while at the same time attempting to wash any dirt off. The containers are especially cumbersome to use to flush the eyes. Even when safety isn't an issue, the drinking water supply may be limited for a particular outing, wherein such use for washing would be wasteful, and the drinking water may be chilled, making it somewhat uncomfortable to use for washing purposes.

Water containers specifically designated for non-drinking purposes customarily lack stability and are prone to tipping over, particularly while traveling. For example, if a cylindrical jug is traveling on the back of a pickup truck or the like, the jug may tip over and roll around, damaging other items or spilling the water.

In addition, containers often have a spigot or other method for dispensing fluid that is located above the lower surface of the container, making it difficult to fully dispense all of the fluid inside the container. Those trying to dispense any remaining fluid would have to lift the container at an angle to force the fluid towards the dispensing spigot. Not only is this an inconvenience, but it may prove to be a daunting task for a large container. In addition, it may be extremely difficult to tilt the container, control the flow of water, and wash-up at the same time, making single-person use of the container especially troublesome.

Known portable hand wash stations often provide bulky, oversized containers which are difficult to carry. Others provide for an electric pump mechanism to aid in dispensing the fluid in the container. However, the absence of the availability of water is likely coupled with the absence of an electrical source, making the use of an electrical pump impossible. Moreover, the weight of the fluid in the container can be difficult enough to manage, let alone the additional weight of a pump feature.

In view of the above limitations, it would be desirable to provide a hand wash system that maintains stability during rough travel and yet easily dispenses the fluid contained in the reservoir.

### SUMMARY OF THE INVENTION

The present invention advantageously provides a hand wash system that maintains stability during rough travel, dispenses water without a pump and provides storage for cleaning accessories.

In an exemplary embodiment, a hand wash system includes a fluid reservoir having an upper face, a lower face and a side face, the lower face having a surface area which is greater than a surface area of the upper face. The hand wash system further includes an opening in the side face for discharging fluid from the reservoir.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an illustration of an exemplary embodiment of the present invention;

FIG. 2 depicts additional features of the present invention; and

FIG. 3 shows further features of the present invention.

### DETAILED DESCRIPTION OF THE INVENTION

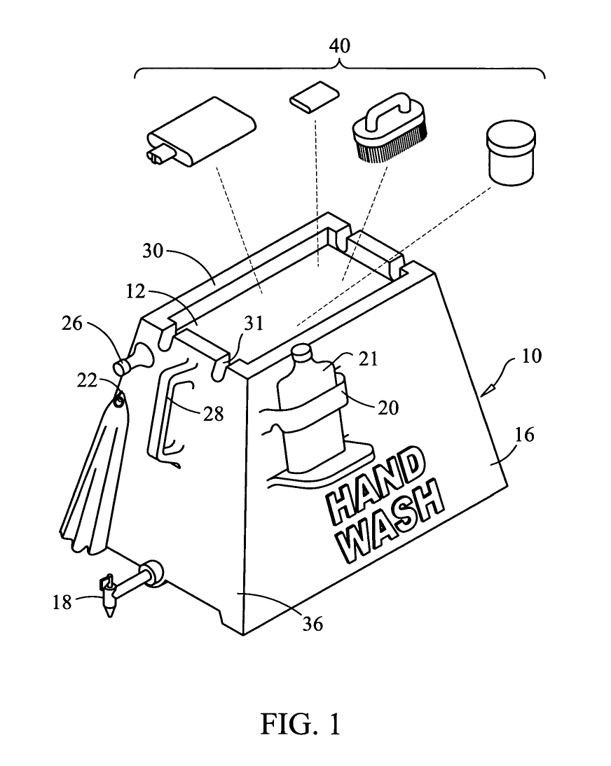

Referring to FIG. 1, the present invention provides a hand wash system comprising a fluid reservoir 10 having an upper face 12, a lower face (not shown), and at least one side face 16, wherein the lower face has a surface area that is greater than the surface area of the upper face 12. The shape of the fluid reservoir may be any such geometric shape that provides for a lower face having a surface area greater than the surface area of the upper face, which may include essentially trapezoidal or frustroconical shapes. The larger lower face provides for greater stability of the hand wash system, thereby reducing the likelihood of tipping. Upper face 12 may include a lip 30 circumscribing the perimeter of the face. The lip 30 may further include drainage slots 31 in the lip 30 to allow fluid accumulating on the surface circumscribed by the lip to be drained. The lip 30 and the upper face 12 together define a storage space in which miscellaneous items 40, including brushes, bottles, containers, etc. can be placed.

The hand wash system further includes an opening 18 in the side face 16 for discharging fluid from the reservoir. The opening 18 can be located on any of the side faces of the fluid reservoir 10, and can further provide means for the attachment of a spigot, valve, screw cap, or any other means by which to control the flow rate of fluid exiting the fluid reservoir 10.

Additionally, the hand wash system includes an integrated soap holder 20, which can be located on any face of fluid reservoir 10. The integrated soap holder 20 can be comprised of a protuberance or other outwardly extending feature shaped to retain the designated shape of the washing soap 21, as shown in FIG. 1.

An exemplary embodiment of the present invention can also include a protrusion 22 for holding a towel. The towel-holding protrusion 22 can be in the form of a loop or ring that a towel can be clipped to, or additionally can be in the form of a hook to simply hang the towel on. The protrusion 22 can be located on any of the side faces of the reservoir 10.

The hand wash system can include a second opening 26 for filling the reservoir 10 with fluid. The second opening 26 can be located on any of the faces of the reservoir 10, and can have a closeable cover including a screw cap or the like. Additionally, the second opening 26 can be left open to serve as a vent. Further, a third opening (not shown) can be provided, wherein the second opening is configured for filling the reservoir 10 and the third opening is configured as a vent. A handle 28 can also be provided by the hand wash system to ease portability, and can be located on any face of the fluid reservoir 10.

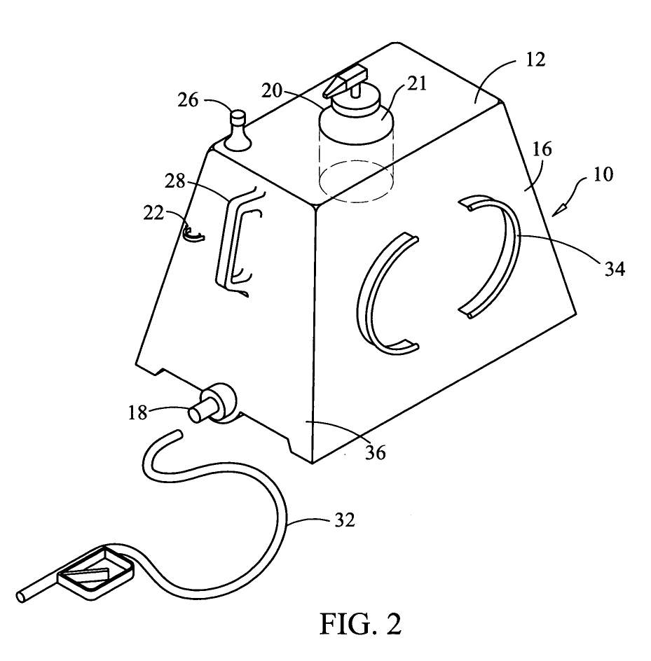

Now referring to FIG. 2, the hand wash system can additionally provide the integrated soap holder 20 in the form of a depression in any of the surfaces of the fluid reservoir 10, and can be of any geometrical orientation as to accommodate washing soap 21, including both cylindrical or rectangular shapes. Moreover, the opening 18 in the reservoir 10 can include means by which to attach a hose 32, as well as providing a hose coiling feature 34 protruding from a face of the reservoir 10 for wrapping the hose 32 around when not in use. In an exemplary embodiment, the hose 32 is made of latex rubber and is provided with a “pinch” closure.

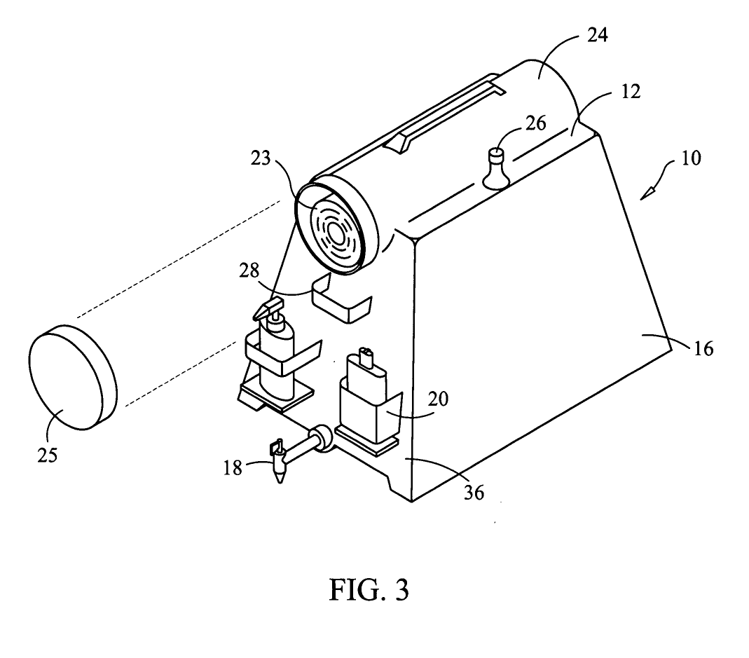

As shown in FIG. 3, the hand wash system can include a towel receptacle 24 having a lid 25. An enclosed compartment on a face of the fluid reservoir 10 can form the receptacle 24 such that a towel or roll of paper towels 23 can be stored and kept separate from the fluid contained in reservoir 10. The receptacle 24 can further provide an extendable rod (not shown) for holding a roll of paper towels.

It will be appreciated by persons skilled in the art that the present invention is not limited to what has been particularly shown and described herein above, and can provide for a combination of any of the features herein described. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A hand wash system, comprising:
a fluid reservoir including an upper face, a lower face and a side face, the lower face having a surface area that is greater than a surface area of the upper face, and
an opening in the side face for discharging fluid from the reservoir.

2. The hand wash system according to claim 1, wherein the hand wash system further includes an integrated soap holder.

3. The hand wash system according to claim 2, wherein the integrated soap holder is located on the upper face of the fluid reservoir.

4. The hand wash system according to claim 2, wherein the integrated soap holder is located on the side face of the fluid reservoir.

5. The hand wash system according to claim 2, wherein the integrated soap holder is comprised of a depression on a face of the fluid reservoir.

6. The hand wash system according to claim 5, wherein the depression is cylindrical.

7. The hand wash system according to claim 5, wherein the depression is rectangular.

8. The hand wash system according to claim 1, wherein the hand wash system further includes a protrusion for holding a towel located on a face of the reservoir.

9. The hand wash system according to claim 1, wherein the hand wash system further includes a receptacle for holding a towel located on a face of the reservoir.

10. The hand wash system according to claim 1, wherein the hand wash system further includes a second opening in a face of the reservoir.

11. The hand wash system according to claim 1, wherein the hand wash system further includes a handle on a face of the reservoir.

12. The hand wash system according to claim 11, wherein the handle is located on the upper surface.

13. The hand wash system according to claim 1, wherein the opening is a spigot.

14. The hand wash system according to claim 1, wherein the upper surface includes a lip.

15. The hand wash system according to claim 14, wherein the lip includes a drainage slot.

16. The hand wash system according to claim 1, wherein the fluid reservoir has an essentially trapezoidal face.

17. The hand wash system according to claim 1, wherein the fluid reservoir has an essentially frustroconical shape.

18. The hand wash system according to claim 1, wherein a hose is affixed to the opening.

19. The hand wash system according to claim 20, wherein the hand wash system further includes a protrusion for holding a coiled hose located on a face of the reservoir.

20. A hand wash system, comprising:
a fluid reservoir having a plurality of faces including an upper face, a lower face, a front face, and a rear face, the lower face having a surface area which is greater than a surface area of the upper face,
a first opening in the front face for discharging fluid from the reservoir, wherein a spigot is attached to the first opening,
a second opening on a face,
an integrated soap holder on a face, and
a handle on a face.
